(19) United States
(12) Patent Application Publication
(10) Pub. No.: US 2026/0217549 A1
(43) Pub. Date: Jul. 30, 2026

(54) METHOD FOR THE EXTRACTION OF LITHIUM

(71) Applicant: Primero Group Limited, Western Australia (AU)

(72) Inventor: Damien A. KREBS, Western Australia (AU)

(21) Appl. No.: 19/142,779

(22) PCT Filed: Nov. 26, 2024
(86) PCT No.: PCT/AU2024/051259

§ 371 Date: Jun. 24, 2025

(30) Foreign Application Priority Data
Nov. 29, 2023 (AU) 2023903857

(51) Int. Cl. C01D 15/08; C01D 7/10; C01D 7/26; C01D 15/02; C22B 1/02; C22B 3/04; C22B 3/44; C22B 26/12

(52) U.S. Cl. CPC C01D 15/08; C01D 7/10; C01D 7/26; C01D 15/02; C22B 1/02; C22B 3/04; C22B 3/44; C22B 26/12

(57) ABSTRACT

A method for the extraction of lithium from a lithium bearing material containing alpha spodumene, the method comprising the steps of: Converting at least a portion of the alpha spodumene present in the lithium bearing material to beta spodumene; Subjecting the lithium bearing material to a leaching process at an elevated pressure in the presence of potassium carbonate to produce a leaching solution containing lithium carbonate; Performing a carbonation process on the leaching solution to convert at least a portion of the lithium carbonate to lithium bicarbonate; Performing a solid-liquid separation process on the leaching solution to separate a leach residue from the leaching solution; Precipitating lithium carbonate from the leaching solution; and Separating precipitated lithium carbonate from the leaching solution.

### TECHNICAL FIELD

The present invention relates to a method for the extraction of lithium. In particular, the present invention relates to a pressure leaching method for the extraction of lithium from lithium ores or concentrates, such as spodumene ores and concentrates.

### BACKGROUND

Lithium and materials containing lithium have a number of industrial applications, such as in heat-resistant glass and ceramics, lithium grease lubricants, flux additives for iron, steel and aluminium production, lithium metal batteries and lithium-ion batteries.

A large proportion of the lithium mined globally is in the form of spodumene, a mineral comprising lithium aluminium silicate. In many conventional extraction processes, spodumene ores are subjected to a leaching process using extraction reagents such as alkali metal sulphates, sulphuric acid, or hydrofluoric acid.

However, conventional extraction processes suffer from the drawbacks that the extraction reagents used present significant environmental and health hazards. Further, conventional extraction processes exhibit low lithium yields and generate large quantities of waste products such as sodium sulphate and lime contaminated tailings.

Some attempts have been made to overcome these problems. For instance, U.S. Pat. No. 9,255,012 discloses a process for extracting lithium from lithium-bearing materials in the presence of high-pressure steam to produce a solution containing lithium carbonate. Although not disclosed in U.S. Pat. No. 9,255,012, it is known that the application of high-pressure steam with sodium carbonate in the leaching phase results in the production of a solid tailings stream which has limited or no commercial use which requires long term environmental management.

Thus, there would be an advantage if it were possible to provide a method for the extraction of lithium that was capable of producing a relatively high-grade lithium product, while reducing or eliminating the generation of unusable waste products.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a method for the extraction of lithium, which may at least partially overcome at least one of the abovementioned disadvantages or provide the consumer with a useful or commercial choice.

In a first aspect, the invention resides broadly in a method for the extraction of lithium from a lithium bearing material containing alpha spodumene, the method comprising the steps of:
Converting at least a portion of the alpha spodumene present in the lithium bearing material to beta spodumene;
Subjecting the lithium bearing material to a leaching process at an elevated temperature and pressure in the presence of potassium carbonate to produce a leaching slurry containing lithium carbonate;
Performing a carbonation process on the leaching slurry to convert at least a portion of the lithium carbonate to lithium bicarbonate;
Performing a solid-liquid separation process on the leaching slurry to separate a leach residue from a separated leaching solution;
Precipitating lithium carbonate from the separated leaching solution; and
Separating precipitated lithium carbonate from the leaching solution.

The lithium bearing material may be of any suitable form. Preferably, however, the lithium bearing material comprises a lithium mineral. In particular, the lithium mineral may comprise a hard rock lithium mineral. Specifically, the lithium mineral may comprise one or more of spodumene, lepidolite, eucryptite and petalite. The lithium bearing material may comprise an ore, a concentrate, a residue or waste product or the like, or any suitable combination thereof. Preferably, however, at least a portion of the lithium in the lithium bearing material is present in the form of spodumene.

The spodumene present in the lithium bearing material may be in the form of alpha spodumene, beta spodumene or a combination thereof. It is envisaged that alpha spodumene is more likely to be present in naturally-occurring materials, such as lithium ores and mineral concentrates, while beta spodumene is more likely to be present in processed materials such as concentrates (including thermally processed concentrates and the like).

In some embodiments of the invention, the lithium bearing material may undergo one or more treatment steps prior to the leaching step. Any suitable treatment steps may be performed, such as a size reduction step, a separation step, a classification step or the like. In a particular embodiment of the invention, the lithium bearing material may undergo a conversion step to convert at least a portion of the alpha spodumene present in the lithium bearing material to beta spodumene.

The conversion step may be of any suitable form, although in a preferred embodiment of the invention the conversion step may comprise a thermal processing step. Specifically, the lithium bearing material may be subject to a roasting process, calcining process or the like, at an elevated temperature to convert at least a portion of the alpha spodumene to beta spodumene. Any suitable elevated temperature may be used, although in a preferred embodiment, the elevated temperature may be between approximately 800° C. and 1200° C. More preferably, the elevated temperature may be between approximately 900° C. and 1100° C.

The thermal processing step may be performed for any suitable period of time, and it will be understood that the length of the thermal processing process may depend on a number of factors, such as the quantity of alpha spodumene present in the lithium bearing material, the particle size of the lithium bearing material, the minerals present in the lithium bearing material and so on.

The thermal processing step may be performed as a batch process or as a continuous process. In a preferred embodiment of the invention the lithium bearing material may be cooled following the thermal processing step, and prior to further processing of the lithium bearing material.

In some embodiments of the invention, the lithium bearing material that has undergone the thermal processing step may be subject to one or more comminution processes and/or one or more classification process prior to the leaching process. In a preferred embodiment of the invention, relatively fine particles of the lithium bearing material may be introduced to the leaching process.

It is envisaged that a significant proportion of the alpha spodumene present in the lithium bearing material may be converted to beta spodumene in the thermal processing step. In some embodiments, at least 70% of the alpha spodumene present in the lithium bearing material may be converted to beta spodumene in the thermal processing step. More preferably, at least 80% of the alpha spodumene present in the lithium bearing material may be converted to beta spodumene in the thermal processing step. More preferably, at least 90% of the alpha spodumene present in the lithium bearing material may be converted to beta spodumene in the thermal processing step. In some embodiments of the invention, it is envisaged that between about 93% and about 96% of the alpha spodumene present in the lithium bearing material may be converted to beta spodumene in the thermal processing step. Thus, in this embodiment, a significant proportion of the lithium present in the lithium bearing material that is subjected to the leaching process is in the form of beta spodumene.

As previously stated, the leaching of the lithium bearing material is performed at an elevated pressure. It will be understood that the term “elevated pressure” refers to a pressure within the leaching reactor vessel that is greater than atmospheric pressure. In a preferred embodiment, the leaching of the lithium bearing material is performed at a temperature at which the natural vapour pressure of the system is greater than 2500 kPa. More preferably, the leaching of the lithium bearing material is performed at a temperature at which the natural vapour pressure of the system is greater than 3500 kPa. Still more preferably, the leaching of the lithium bearing material is performed at a temperature at which the natural vapour pressure of the system is greater than 4500 kPa. Most preferably, the leaching of the lithium bearing material is performed at a temperature at which the natural vapour pressure of the system is greater than 5000 kPa. In a specific embodiment, the leaching of the lithium bearing material is performed at a temperature at which the natural vapour pressure of the system is between about 4500 kPa and 5500 kPa.

In some embodiments of the invention, it is envisaged that the pressure at which the leaching of the lithium bearing material is performed may be greater than the natural vapour pressure at a given temperature. In these embodiments of the invention, the system pressure may be increased to greater than the natural vapour pressure in order to reduce or eliminate the boiling of liquid in the leaching vessel. While the pressure may be raised to any suitable level, it is envisaged that the pressure may be raised by up to 700 kPa above the natural vapour pressure. In a preferred embodiment, the pressure in the leaching vessel may be raised by between 300 kPa and 600 kPa above the natural vapour pressure.

The leaching process may be conducted in any suitable vessel. Preferably, however, the vessel comprises a pressure vessel. In a particular embodiment of the invention, the vessel comprises an autoclave. In some embodiments of the invention, the pressure vessel may be agitated. In a specific embodiment, the pressure vessel may be in the form of a stirred horizontal autoclave, Pachuca tank, or a pipe reactor.

It is envisaged that the leaching process may be performed at an elevated temperature. It will be understood that the term “elevated temperature” refers to a temperature that is greater than ambient temperature. In a preferred embodiment, the leaching of the lithium bearing material is performed at a temperature of greater than 250° C. More preferably, the leaching of the lithium bearing material is performed at a temperature of greater than 250° C. but less than 300° C. More preferably, the leaching of the lithium bearing material is performed at a temperature of greater than 250° C. but less than 285° C. Most preferably, the leaching of the lithium bearing material is performed at a temperature of greater than 250° C. but less than 270° C.

Preferably, the temperature at which the leaching of the lithium bearing material is performed is configured to be below the boiling point of the leaching solution. More preferably, the temperature at which the leaching of the lithium bearing material is performed is configured to be below, but relatively close to, the boiling point of the leaching solution.

It is envisaged that the lithium bearing material may be introduced to the leaching process in the form of solid material. As previously stated, the lithium bearing material is leached in the presence of a potassium carbonate solution. Preferably, the lithium bearing material is introduced to a lixiviant containing potassium carbonate and, in particular, an aqueous solution of potassium carbonate.

It will be understood that the lixiviant may comprise ions or compounds other than potassium carbonate. For instance, the lixiviant may comprise potassium bicarbonate.

The lixiviant may have any suitable concentration of potassium carbonate. For instance, the concentration of potassium carbonate in the lixiviant may be between about 10 g/L and 900 g/L. More preferably, the concentration of potassium carbonate in the lixiviant may be between about 15 g/L and 700 g/L. More preferably, the concentration of potassium carbonate in the lixiviant may be between about 20 g/L and 500 g/L. More preferably, the concentration of potassium carbonate in the lixiviant may be between about 25 g/L and 400 g/L. Most preferably, the concentration of potassium carbonate in the lixiviant may be between about 30 g/L and 300 g/L.

In a particular embodiment of the invention, the leaching of lithium bearing material (in the form of beta spodumene) may proceed according to the following reaction:

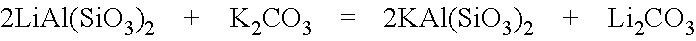

In this embodiment, it is envisaged that the leaching reaction may result in the extraction of lithium from the beta spodumene through the exchange of lithium and potassium ions. The potassium aluminium silicate present in the leaching slurry may be in the form of a solid, while the lithium carbonate generated by the leaching reaction may be present in the form of a precipitated solid and/or in aqueous form in the leaching solution. In some embodiments, lithium carbonate may be present in the leaching solution in both solid and aqueous forms.

In some embodiments, the potassium aluminium silicate present in the leaching solution may be partially comprised of the mineral leucite.

The leaching process may be performed for any suitable period of time. Preferably, however, the residence time of the leaching process may be between about 5 minutes and about 130 minutes. More preferably, the residence time of the leaching process may be between about 10 minutes and about 120 minutes. It will be understood that the residence time may be dependent on a number of factors, such as the nature of the lithium bearing material, the temperature at which the leaching process is conducted, the concentration of potassium carbonate in the lixiviant, the particle size of the lithium bearing material and so on.

The leaching process may be performed as a batch process or as a continuous process. Preferably, however, the leaching process may be a continuous process.

In some embodiments of the invention, the leaching solution may be treated to recover heat at the conclusion of the leaching process. Heat may be recovered using any suitable technique, although in a preferred embodiment, heat may be recovered using a heat exchange process. The heat exchange fluid used to recover heat from the leaching solution may be of any suitable form. In some embodiments of the invention, the heat exchange fluid may be a process stream generated or used in another part of the method.

As previously stated, a carbonation process is performed on the solids of the leaching solution to convert at least a portion of the lithium carbonate in the leaching slurry to lithium bicarbonate. The carbonation process may be performed using any suitable reactant, although in a preferred embodiment of the invention, the reactant may be a gas containing carbon. In a particular embodiment, the reactant may comprise carbon dioxide.

It is envisaged that the lithium carbonate converted to lithium bicarbonate may be the solid lithium carbonate in the leaching slurry. Preferably, lithium carbonate is converted to lithium bicarbonate according to the following reaction:

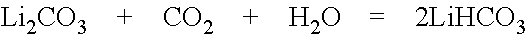

The carbonation process may be performed at any suitable temperature, and it is envisaged that the temperature may be chosen to enhance the solubility of the lithium bicarbonate. In a preferred embodiment of the invention, the carbonation process may be performed at a temperature of no more than about 70° C. More preferably, the carbonation process may be performed at a temperature of no more than about 60° C. Most preferably, the carbonation process may be performed at a temperature of no more than about 40° C.

The carbonation process may be performed at any suitable pressure, including at atmospheric pressure, or at greater than atmospheric pressure.

The carbonation process may be performed as a continuous process or as a batch process and may be performed in any suitable vessel, such as, but not limited to, autoclaves, adsorption towers, deep stirred tanks, atmospheric stirred tanks, or any suitable combination thereof. In a particular embodiment of the invention, the vessel comprises a deep atmospheric stirred tank.

Preferably, the carbonation process may solubilise at least 70% of the solid lithium carbonate in the leaching slurry. More preferably, the carbonation process may solubilise at least 80% of the solid lithium carbonate in the leaching solution. Even more preferably, the carbonation process may solubilise at least 90% of the solid lithium carbonate in the leaching solution. In some embodiments, the carbonation process may solubilise approximately 95% of the solid lithium carbonate in the leaching solution. It is envisaged that at least a portion of the lithium that is not solubilised by the carbonation process may be present as residual alpha spodumene and therefore may not be available for carbonate dissolution.

Following the carbonation process, a solid-liquid separation process is performed on the leaching solution from the carbonation process to separate a leach residue from the leaching solution. In this way, a concentrated lithium bearing leaching solution may be obtained. The concentrated lithium bearing solution may be collected for subsequent processing.

Any suitable solid-liquid separation process may be used. For instance, the solid-liquid separation process may comprise a filtration process, an evaporation or drying process or the like. In other embodiments, a settling or decantation process (such as a single-stage or multi-stage process conducted in a thickener) may be performed to separate a clarified leaching solution from the solid leaching residue.

In some embodiments of the invention, the leaching residue may, once separated from the leaching solution, be washed or otherwise cleaned in order to remove at least a portion of soluble species present thereon. The leaching residue may be washed or otherwise cleaned once, or may be washed or cleaned during two or more steps in the method.

It is envisaged that the leaching residue may form a tailings product from the extraction method. Beneficially, however, it is envisaged that the leaching residue may contain relatively high concentrations of potassium. It is envisaged that, rather than being collected in an environmental impoundment or stored in a tailings residue facility, the leaching residue may constitute a valuable by-product of the extraction method. For instance, the leaching residue, having a relatively high potassium concentration (and particularly a relatively high bioavailable potassium concentration), may be used as a fertiliser, and particularly a slow-release fertiliser.

The fertiliser may comprise any suitable quantity of potassium. For instance, the fertiliser may comprise between about 1% w/w potassium and about 20% w/w potassium. More preferably, the fertiliser may comprise between about 3% w/w potassium and about 16% w/w potassium. Still more preferably, the fertiliser may comprise between about 5% w/w potassium and about 15% w/w potassium.

Thus, the present invention provides a significant advantage in that, instead of generating a potentially hazardous tailings product that must undergo managed environmental storage or otherwise disposed of, the present invention generates a useful by-product, thereby reducing or eliminating waste produced by the method.

After the solid-liquid separation, the leaching solution is relatively free from solids and has a relatively high soluble lithium concentration. Lithium may then be precipitated from the leaching solution in the form of lithium carbonate by altering the solution chemistry.

Any suitable precipitation reaction may be used, although in a preferred embodiment of the invention one or more ions may be introduced to the leaching solution in order to convert soluble lithium bicarbonate to relatively insoluble lithium carbonate. Any suitable ions may be used, although in a preferred embodiment, the ions may comprise hydroxide ions (and may be provided in the form of, for instance, sodium hydroxide). More preferably, the hydroxide ions may be provided in the form of potassium hydroxide. In this embodiment, the lithium carbonate precipitation proceeds according to the following reaction:

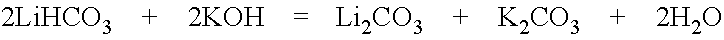

Beneficially, the use of potassium hydroxide results in a leaching solution containing aqueous potassium carbonate. Thus, once the precipitated lithium carbonate is separated from the leaching solution, the leaching solution may be returned to the leaching process as the lixiviant.

In a preferred embodiment of the invention, the precipitation of lithium carbonate may be conducted at an elevated temperature. Preferably, the precipitation of lithium carbonate may be performed at a temperature of between about 30° C. and 90° C.

In some embodiments, the temperature of the leaching solution may be elevated using a heat source, such as a burner, steam injection, heater or the like. In an alternative embodiment, the temperature of the leaching solution may be elevated using a heat exchange process. The heat exchange fluid may be of any suitable type, although in a preferred embodiment of the invention, the heat exchange fluid may comprise leaching solution leaving the leaching process. In this way, the leaching solution leaving the leaching process may be cooled and the leaching solution undergoing lithium carbonate precipitation may be heated, thereby reducing or eliminating the need for an external heat source.

Precipitated lithium carbonate may be separated from the leaching solution using any suitable technique. For instance, the precipitated lithium carbonate may be separated using a filtration process, an evaporation or drying process or the like. In other embodiments, a settling or thickening process may be performed to separate a clarified leaching solution from the precipitated lithium carbonate.

It has been found that the extraction method of the present invention results in a commercially viable recovery of lithium from the lithium bearing material. In addition, the lithium carbonate product produced by the method is of a relatively high purity. Further, the present method generates streams that may be recycled to other points in the process, thereby reducing reagent costs. Finally, and as previously mentioned, the present invention generates a useful by-product rather than a potentially hazardous tailings product that must be stored or otherwise disposed of.

In a second aspect, the invention resides broadly in a method for the extraction of lithium from a lithium bearing material containing alpha spodumene, the method comprising the steps of:
Converting at least a portion of the alpha spodumene present in the lithium bearing material to beta spodumene;
Subjecting the lithium bearing material to a first leaching process at an elevated pressure in the presence of potassium carbonate to precipitate lithium carbonate;
Subjecting the lithium carbonate to a second leaching process in the presence of hydroxide ions to produce a leaching solution containing an aqueous solution of lithium hydroxide;
Separating a solid leach residue from the leaching slurry to produce a lithium hydroxide bearing solution; and
Producing a solid lithium hydroxide product from the lithium hydroxide bearing solution.

The lithium bearing material may be of any suitable form of a lithium mineral. In general, the lithium mineral may be spodumene, lepidolite, eucryptite and petalite. For instance, the lithium bearing material may comprise an ore, a concentrate, a residue or waste product or the like, or any suitable combination thereof. Preferably, however, at least a portion of the lithium in the lithium bearing material is present in the form of spodumene.

The spodumene present in the lithium bearing material may be in the form of alpha spodumene, beta spodumene or a combination thereof. It is envisaged that alpha spodumene is more likely to be present in naturally-occurring materials (such as lithium ores), while beta spodumene is more likely to be present in materials such as concentrates and the like.

In some embodiments of the invention, the lithium bearing material may undergo one or more treatment steps prior to the leaching step. Any suitable treatment steps may be performed, such as a size reduction step, a separation step, a classification step or the like. In a particular embodiment of the invention, the lithium bearing material may undergo a conversion step to convert at least a portion of the alpha spodumene present in the lithium bearing material to beta spodumene.

The conversion step may be of any suitable form, although in a preferred embodiment of the invention the conversion step may comprise a heat treatment step. Specifically, the lithium bearing material may be subject to a roasting process, calcining process or the like, at an elevated temperature to convert at least a portion of the alpha spodumene to beta spodumene. Any suitable elevated temperature may be used, although in a preferred embodiment, the elevated temperature may be between approximately 800° C. and 1200° C. More preferably, the elevated temperature may be between approximately 900° C. and 1100° C.

The heat treatment step may be performed for any suitable period of time, and it will be understood that the length of the heat treatment process may depend on a number of factors, such as the quantity of alpha spodumene present in the lithium bearing material, the particle size of the lithium bearing material, the minerals present in the lithium bearing material and so on.

The heat treatment step may be performed as a batch process or as a continuous process. In a preferred embodiment of the invention the lithium bearing material may be cooled following the heat treatment step, and prior to further processing of the lithium bearing material.

In some embodiments of the invention, the lithium bearing material that has undergone the heat treatment step may be subject to one or more comminution processes and/or one or more classification processes prior to the leaching process. In a preferred embodiment of the invention, relatively fine particles of the lithium bearing material may be introduced to the leaching process.

Any suitable size reduction process may be used, although in a preferred embodiment of the invention the size reduction process may comprise a comminution process, such as crushing, grinding or the like. The comminution process may be performed using any suitable method, such as ball milling, vertical stirred milling, jet milling, or any other suitable mechanical grinding. The grinding process may be performed as a wet or dry process, but in the preferred embodiment, the grinding process may be a wet grinding process using recycled lixiviant solution, such as a recycled potassium carbonate lixiviant solution.

It is envisaged that a significant proportion of the alpha spodumene present in the lithium bearing material may be converted to beta spodumene in the heat treatment step. In some embodiments, at least 70% of the alpha spodumene present in the lithium bearing material may be converted to beta spodumene in the heat treatment step. More preferably, at least 80% of the alpha spodumene present in the lithium bearing material may be converted to beta spodumene in the heat treatment step. More preferably, at least 90% of the alpha spodumene present in the lithium bearing material may be converted to beta spodumene in the heat treatment step. In some embodiments of the invention, it is envisaged that between about 93% and about 96% of the alpha spodumene present in the lithium bearing material may be converted to beta spodumene in the heat treatment step. Thus, in this embodiment, a significant proportion of the lithium present in the lithium bearing material that is subjected to the leaching process is in the form of beta spodumene.

As previously stated, the leaching of the lithium bearing material is performed at an elevated pressure. It will be understood that the term “elevated pressure” refers to a pressure that is greater than atmospheric pressure. In a preferred embodiment, the leaching of the lithium bearing material is performed at a pressure of greater than 2500 kPa. More preferably, the leaching of the lithium bearing material is performed at a pressure of greater than 3500 kPa. Still more preferably, the leaching of the lithium bearing material is performed at a pressure of greater than 4500 kPa. Most preferably, the leaching of the lithium bearing material is performed at a pressure of greater than 5000 kPa. In a specific embodiment, the leaching of the lithium bearing material is performed at a pressure of between about 4500 kPa and 5500 kPa.

In some embodiments of the invention, it is envisaged that the pressure at which the leaching of the lithium bearing material is performed may be greater than the steam pressure at a given temperature. In these embodiments of the invention, the pressure may be increased to greater than the steam pressure in order to reduce or eliminate the boiling of liquid in the leaching vessel. While the pressure may be raised to any suitable level, it is envisaged that the pressure may be at least 30 kPa above the steam pressure. In a preferred embodiment, the pressure in the leaching vessel may be raised by between 300 kPa and 600 kPa above the steam pressure.

The leaching process may be conducted in any suitable vessel. Preferably, however, the vessel comprises a pressure vessel. In a particular embodiment of the invention, the vessel comprises an autoclave. In some embodiments of the invention, the pressure vessel may be agitated. In a specific embodiment, the pressure vessel may be in the form of a stirred horizontal autoclave, Pachuca tank, or a pipe reactor.

It is envisaged that the leaching process may be performed at an elevated temperature. It will be understood that the term “elevated temperature” refers to a temperature that is greater than ambient temperature. In a preferred embodiment, the leaching of the lithium bearing material is performed at a temperature of greater than 250° C. More preferably, the leaching of the lithium bearing material is performed at a temperature of greater than 250° C. but less than 300° C. More preferably, the leaching of the lithium bearing material is performed at a temperature of greater than 250° C. but less than 285° C. Most preferably, the leaching of the lithium bearing material is performed at a temperature of greater than 250° C. but less than 270° C.

It is envisaged that the lithium bearing material may be introduced to the leaching process in the form of solid material. As previously stated, the lithium bearing material is leached in the presence of a potassium carbonate solution. Preferably, the lithium bearing material is introduced to a lixiviant containing potassium carbonate and, in particular, an aqueous solution of potassium carbonate.

It will be understood that the lixiviant may comprise ions or compounds other than potassium carbonate. For instance, the lixiviant may comprise potassium bicarbonate.

The lixiviant may have any suitable concentration of potassium carbonate. For instance, the concentration of potassium carbonate in the lixiviant may be between about 10 g/L and 900 g/L. More preferably, the concentration of potassium carbonate in the lixiviant may be between about 15 g/L and 700 g/L. More preferably, the concentration of potassium carbonate in the lixiviant may be between about 20 g/L and 500 g/L. More preferably, the concentration of potassium carbonate in the lixiviant may be between about 25 g/L and 400 g/L. Most preferably, the concentration of potassium carbonate in the lixiviant may be between about 30 g/L and 300 g/L.

In a particular embodiment of the invention, the leaching of lithium bearing material (in the form of beta spodumene) may proceed according to the following reaction:

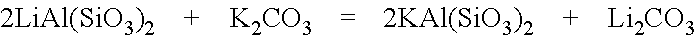

In this embodiment, it is envisaged that the leaching reaction may result in the extraction of lithium from the beta spodumene through the exchange of lithium and potassium ions. The potassium aluminium silicate present in the leaching solution may be in the form of a solid, while the lithium carbonate generated by the leaching reaction may be present in the form of a precipitated solid and/or in aqueous form in the leaching solution. In some embodiments, lithium carbonate may be present in the leaching solution in both solid and aqueous forms.

The leaching process may be performed for any suitable period of time. Preferably, however, the residence time of the leaching process may be between about 5 minutes and about 130 minutes. More preferably, the residence time of the leaching process may be between about 10 minutes and about 120 minutes. It will be understood that the residence time may be dependent on a number of factors, such as the nature of the lithium bearing material, the temperature at which the leaching process is conducted, the concentration of potassium carbonate in the lixiviant, the particle size of the lithium bearing material and so on.

The leaching process may be performed as a batch process or as a continuous process. Preferably, however, the leaching process may be a continuous process.

In some embodiments of the invention, the leaching solution may be treated to recover heat at the conclusion of the leaching process. Heat may be recovered using any suitable technique, although in a preferred embodiment, heat may be recovered using a heat exchange process. The heat exchange fluid used to recover heat from the leaching solution may be of any suitable form. In some embodiments of the invention, the heat exchange fluid may be a process stream generated or used in another part of the method.

As previously stated, the lithium carbonate is subjected to a second leaching process in the presence of hydroxide ions to produce a leaching solution containing an aqueous solution of lithium hydroxide. However, before the second leaching process takes place, one or more process steps may be performed on the stream exiting the first leaching process.

In particular, it is envisaged that the stream exiting the first leaching process may comprise leached solids (including lithium carbonate) in a solution that is relatively high in potassium. Thus, in some embodiments, a solid-liquid separation process may be performed on the stream exiting the first leaching process.

Any suitable solid-liquid separation process may be used. For instance, the solid-liquid separation process may comprise a filtration process, an evaporation or drying process or the like. In other embodiments, a settling process or a counter current decantation process (such as one conducted in a thickener) may be performed to separate a clarified solution from the leached solids.

In some embodiments of the invention, the leached solids may, once separated from the clarified solution, be washed or otherwise cleaned in order to remove at least a portion of soluble species present thereon.

The leached solids (including the lithium carbonate) may be subjected to the second leaching process. The second leaching process may be conducted at any suitable pressure, including at greater than atmospheric pressure. In some embodiments of the invention, the second leaching process may be conducted at atmospheric pressure.

The second leaching process may be performed at any suitable temperature, and it is envisaged that the temperature may be chosen to enhance the solubility of the lithium species. In a preferred embodiment of the invention, the second leaching process may be performed at a temperature of no more than about 70° C. More preferably, the second leaching process may be performed at a temperature of no more than about 60° C. Most preferably, the second leaching process may be performed at a temperature of no more than about 50° C.

As previously stated, the second leaching process is conducted in the presence of hydroxide ions. Preferably, the second leaching process is conducted in the presence of cations that form substantially insoluble carbonate compounds. For instance, the second leaching process may be conducted in the presence of cations of barium, calcium, strontium and/or magnesium. Thus, in this embodiment of the invention, the cation component of the lixiviant is selected to be substantially insoluble when combined with the carbonate anion from the lithium carbonate. In this way, contamination of the leaching solution by cations and/or carbonate ions may be reduced or eliminated. In this embodiment of the invention, it is envisaged that at least a portion of the products of the second leaching process may be precipitated calcium carbonate, barium carbonate, strontium carbonate and/or magnesium carbonate and an aqueous solution of lithium hydroxide. It is envisaged that the aqueous solution of lithium hydroxide may also comprise potassium ions.

It will be understood that the quantity of potassium in the solid leach residue will be dependent on a number of factors. However, in a preferred embodiment of the invention it is envisaged that the solid leach residue may comprise between about 2% w/w potassium and about 20% w/w potassium. More preferably, the solid leach residue may comprise between about 2.5% w/w potassium and about 16% w/w potassium. Still more preferably, the solid leach residue may comprise between about 3% w/w potassium and about 15% w/w potassium.

The second leaching process may be performed for any suitable period of time. Preferably, however, the residence time of the second leaching process may be between about 5 minutes and about 130 minutes. More preferably, the residence time of the second leaching process may be between about 10 minutes and about 120 minutes. It will be understood that the residence time may be dependent on a number of factors, such as the composition of the leached solids, the temperature at which the leaching process is conducted, the concentration of hydroxide ions in the lixiviant, the particle size of the leached solids and so on.

The leaching process may be performed as a batch process or as a continuous process. Preferably, however, the leaching process may be a continuous process.

The step of separating the solid leach residue to produce a lithium hydroxide solution may be performed using any suitable technique. Preferably, a solid-liquid separation process may be performed to separate the solid leach residue from the lithium hydroxide solution.

Any suitable solid-liquid separation process may be used. For instance, the solid-liquid separation process may comprise a filtration process, an evaporation or drying process or the like. In other embodiments, a settling process or a counter current decantation process (such as one conducted in a thickener) may be performed to separate lithium hydroxide solution from the solid leach residue.

In some embodiments of the invention, the solid leach residue may, once separated from the lithium hydroxide bearing solution, be washed or otherwise cleaned in order to remove at least a portion of soluble species present thereon.

It is envisaged that the solid leach residue may form a tailings product from the extraction method. Beneficially, however, it is envisaged that the solid leach residue may constitute a valuable byproduct of the extraction method. For instance, the solid leach residue may be used as a fertiliser, and particularly a slow-release fertiliser, due to its relatively high potassium concentration.

As previously stated, a solid lithium hydroxide product is produced from the lithium hydroxide bearing solution. The solid lithium hydroxide product may be of any suitable form, and may be anhydrous or hydrated. In some embodiments, the solid lithium hydroxide product may be in the form of crystalline lithium hydroxide.

The solid lithium hydroxide product may be produced directly from the lithium hydroxide bearing solution, or the lithium hydroxide bearing solution may undergo one or more additional processing steps prior to the production of the solid lithium hydroxide product.

In another embodiment of the invention, the lithium hydroxide solution undergoes a purification step in the form of a partial evaporation to crystallise relatively high purity lithium hydroxide monohydrate. The purification step may include an ion exchange process to remove di- and tri-valent cations before subjecting the lithium hydroxide solution stream to a crystallisation process.

For instance, the lithium hydroxide solution may undergo a purification step prior to the production of the solid lithium hydroxide product. Any suitable purification process may be used, although in some embodiments of the invention, the process may comprise a crystallisation process. For instance, the lithium hydroxide solution may be partially evaporated to crystallise relatively high purity lithium hydroxide monohydrate. Alternatively, or in addition to, the lithium hydroxide solution may be subjected to a crystallisation process, such as vapour recompression crystallisation to produce lithium hydroxide crystals forming the solid lithium hydroxide product.

In a third aspect, the invention resides broadly in a method for the extraction of lithium from a lithium bearing material containing alpha spodumene, the method comprising the steps of:
Converting at least a portion of the alpha spodumene present in the lithium bearing material to beta spodumene;
Subjecting the lithium bearing material to a leaching process at an elevated temperature in the presence of potassium carbonate to produce a leaching slurry containing lithium carbonate;
Performing a carbon dioxide leaching process on the leaching slurry to produce a bicarbonate leaching slurry in which at least a portion of the lithium carbonate is converted to lithium bicarbonate;
Performing a solid-liquid separation process on the bicarbonate leaching slurry to separate a leach residue from a leaching solution;
Precipitating lithium carbonate from the leaching solution; and
Separating precipitated lithium carbonate from the leaching solution.

The lithium bearing material may be of any suitable form of a lithium mineral. In general, the lithium mineral can be spodumene, lepidolite, eucryptite and petalite. The lithium bearing material may comprise an ore, a concentrate, a residue or waste product or the like, or any suitable combination thereof. Preferably, however, at least a portion of the lithium in the lithium bearing material is present in the form of spodumene.

The spodumene present in the lithium bearing material may be in the form of alpha spodumene, beta spodumene or a combination thereof. It is envisaged that alpha spodumene is more likely to be present in naturally-occurring materials, such as lithium ores and mineral concentrates, while beta spodumene is more likely to be present in processed materials such as concentrates (including thermally processed concentrates and the like).

In some embodiments of the invention, the lithium bearing material may undergo one or more treatment steps prior to the leaching step. Any suitable treatment steps may be performed, such as a size reduction step, a separation step, a classification step or the like. In a particular embodiment of the invention, the lithium bearing material may undergo a conversion step to convert at least a portion of the alpha spodumene present in the lithium bearing material to beta spodumene.

The conversion step may be of any suitable form, although in a preferred embodiment of the invention the conversion step may comprise a thermal processing step. Specifically, the lithium bearing material may be subject to a roasting process, calcining process or the like, at an elevated temperature to convert at least a portion of the alpha spodumene to beta spodumene. Any suitable elevated temperature may be used, although in a preferred embodiment, the elevated temperature may be between approximately 800° C. and 1200° C. More preferably, the elevated temperature may be between approximately 900° C. and 1100° C.

The thermal processing step may be performed for any suitable period of time, and it will be understood that the length of the thermal processing process may depend on a number of factors, such as the quantity of alpha spodumene present in the lithium bearing material, the particle size of the lithium bearing material, the minerals present in the lithium bearing material and so on.

The thermal processing step may be performed as a batch process or as a continuous process. In a preferred embodiment of the invention the lithium bearing material may be cooled following the thermal processing step, and prior to further processing of the lithium bearing material.

In some embodiments of the invention, the lithium bearing material that has undergone the thermal processing step may be subject to one or more comminution processes and/or one or more classification process prior to the leaching process. In a preferred embodiment of the invention, relatively fine particles of the lithium bearing material may be introduced to the leaching process.

It is envisaged that a significant proportion of the alpha spodumene present in the lithium bearing material may be converted to beta spodumene in the thermal processing step. In some embodiments, at least 70% of the alpha spodumene present in the lithium bearing material may be converted to beta spodumene in the thermal processing step. More preferably, at least 80% of the alpha spodumene present in the lithium bearing material may be converted to beta spodumene in the thermal processing step. More preferably, at least 90% of the alpha spodumene present in the lithium bearing material may be converted to beta spodumene in the thermal processing step. In some embodiments of the invention, it is envisaged that between about 93% and about 96% of the alpha spodumene present in the lithium bearing material may be converted to beta spodumene in the thermal processing step. Thus, in this embodiment, a significant proportion of the lithium present in the lithium bearing material that is subjected to the leaching process is in the form of beta spodumene.

In some embodiments of the invention, it is envisaged that the pressure at which the leaching of the lithium bearing material is performed may be greater than the natural vapour pressure at a given temperature. In these embodiments of the invention, the system pressure may be increased to greater than the natural vapour pressure in order to reduce or eliminate the boiling of liquid in the leaching vessel. While the pressure may be raised to any suitable level, it is envisaged that the pressure may be raised by up to 700 kPa above the natural vapour pressure. In a preferred embodiment, the pressure in the leaching vessel may be raised by between 300 kPa and 600 kPa above the natural vapour pressure.

The leaching process may be conducted in any suitable vessel. Preferably, however, the vessel comprises a pressure vessel. In a particular embodiment of the invention, the vessel comprises an autoclave. In some embodiments of the invention, the pressure vessel may be agitated. In a specific embodiment, the pressure vessel may be in the form of a stirred horizontal autoclave, Pachuca tank, or a pipe reactor.

It is envisaged that the leaching process may be performed at an elevated temperature. It will be understood that the term “elevated temperature” refers to a temperature that is greater than ambient temperature. In a preferred embodiment, the leaching of the lithium bearing material is performed at a temperature of greater than 250° C. More preferably, the leaching of the lithium bearing material is performed at a temperature of greater than 250° C. but less than 300° C. More preferably, the leaching of the lithium bearing material is performed at a temperature of greater than 250° C. but less than 285° C. Most preferably, the leaching of the lithium bearing material is performed at a temperature of greater than 250° C. but less than 270° C.

Preferably, the temperature at which the leaching of the lithium bearing material is performed is configured to be below the boiling point of the leaching solution. More preferably, the temperature at which the leaching of the lithium bearing material is performed is configured to be below, but relatively close to, the boiling point of the leaching solution.

It is envisaged that the lithium bearing material may be introduced to the leaching process in the form of solid material. As previously stated, the lithium bearing material is leached in the presence of a potassium carbonate solution. Preferably, the lithium bearing material is introduced to a lixiviant containing potassium carbonate and, in particular, an aqueous solution of potassium carbonate.

It will be understood that the lixiviant may comprise ions or compounds other than potassium carbonate. For instance, the lixiviant may comprise potassium bicarbonate.

The lixiviant may have any suitable concentration of potassium carbonate. For instance, the concentration of potassium carbonate in the lixiviant may be between about 10 g/L and 900 g/L. More preferably, the concentration of potassium carbonate in the lixiviant may be between about 15 g/L and 700 g/L. More preferably, the concentration of potassium carbonate in the lixiviant may be between about 20 g/L and 500 g/L. More preferably, the concentration of potassium carbonate in the lixiviant may be between about 25 g/L and 400 g/L. Most preferably, the concentration of potassium carbonate in the lixiviant may be between about 30 g/L and 300 g/L.

In a particular embodiment of the invention, the leaching of lithium bearing material (in the form of beta spodumene) may proceed according to the following reaction:

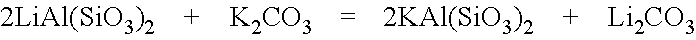

In this embodiment, it is envisaged that the leaching reaction may result in the extraction of lithium from the beta spodumene through the exchange of lithium and potassium ions. The potassium aluminium silicate present in the leaching slurry may be in the form of a solid, while the lithium carbonate generated by the leaching reaction may be present in the form of a precipitated solid and/or in aqueous form in the leaching solution. In some embodiments, lithium carbonate may be present in the leaching solution in both solid and aqueous forms.

In some embodiments, the potassium aluminium silicate present in the leaching solution may be partially comprised of the mineral leucite.

The leaching process may be performed for any suitable period of time. Preferably, however, the residence time of the leaching process may be between about 5 minutes and about 90 minutes. It will be understood that the residence time may be dependent on a number of factors, such as the nature of the lithium bearing material, the temperature at which the leaching process is conducted, the concentration of potassium carbonate in the lixiviant, the particle size of the lithium bearing material and so on.

The leaching process may be performed as a batch process or as a continuous process. Preferably, however, the leaching process may be a continuous process.

In some embodiments of the invention, the leaching slurry may be treated to recover heat at the conclusion of the leaching process. Heat may be recovered using any suitable technique, although in a preferred embodiment, heat may be recovered using a heat exchange process. The heat exchange fluid used to recover heat from the leaching slurry may be of any suitable form. In some embodiments of the invention, the heat exchange fluid may be a process stream generated or used in another part of the method.

One or more process steps may be performed on the leaching slurry exiting the first leaching process.

In particular, it is envisaged that the leaching slurry may comprise leached solids (including the lithium carbonate) in a solution that is relatively high in potassium. Thus, in some embodiments, a solid-liquid separation process may be performed on the leaching slurry.

Any suitable solid-liquid separation process may be used. For instance, the solid-liquid separation process may comprise a filtration process, an evaporation or drying process or the like. In other embodiments, a settling process or a counter current decantation process (such as one conducted in a thickener) may be performed to separate a clarified leaching solution from the leached solids. The leaching solution may be recycled to another point in the process. For instance, the leaching solution may be recycled to the leaching process.

In some embodiments of the invention, the leached solids may, once separated from the clarified leaching solution, be washed or otherwise cleaned in order to remove at least a portion of soluble species present thereon.

The leached solids may be treated in the presence of a carbonate solution. Any suitable treatment may be used, although in some embodiments the treatment may comprise repulping the leached solid with the carbonate solution. Any suitable carbonate solution may be used, such as lithium carbonate, potassium carbonate, or a combination of the two.

As previously stated, a carbon dioxide leaching process is performed on the solids of the leaching slurry to convert at least a portion of the lithium carbonate in the leaching slurry to lithium bicarbonate. The carbon dioxide leaching process may be performed using any suitable reactant, although in a preferred embodiment of the invention, the reactant may be a gas containing carbon. In a particular embodiment, the reactant may comprise carbon dioxide.

It is envisaged that the lithium carbonate converted to lithium bicarbonate may be the solid lithium carbonate in the leaching slurry. Preferably, lithium carbonate is converted to lithium bicarbonate according to the following reaction:

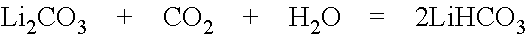

The carbon dioxide leaching process may be performed at any suitable temperature, and it is envisaged that the temperature may be chosen to enhance the solubility of the lithium bicarbonate. In a preferred embodiment of the invention, the carbonation process may be performed at a temperature of no more than about 70° C. More preferably, the carbonation process may be performed at a temperature of no more than about 60° C. Most preferably, the carbonation process may be performed at a temperature of no more than about 40° C.

The carbon dioxide leaching process may be performed at any suitable pressure, including at atmospheric pressure, or at greater than atmospheric pressure.

The carbon dioxide leaching process may be performed as a continuous process or as a batch process and may be performed in any suitable vessel, such as, but not limited to, autoclaves, adsorption towers, deep stirred tanks, atmospheric stirred tanks, or any suitable combination thereof. In a particular embodiment of the invention, the vessel comprises a deep atmospheric stirred tank.

Preferably, the carbon dioxide leaching process may solubilise at least 70% of the solid lithium carbonate in the leaching slurry. More preferably, the carbon dioxide leaching process may solubilise at least 80% of the solid lithium carbonate in the leaching solution. Even more preferably, the carbon dioxide leaching process may solubilise at least 90% of the solid lithium carbonate in the leaching solution. In some embodiments, the carbon dioxide leaching process may solubilise approximately 95% of the solid lithium carbonate in the leaching solution. It is envisaged that at least a portion of the lithium may be present as residual alpha spodumene from the carbonate leaching step, and therefore may not be available for carbonate dissolution.

Following the carbon dioxide leaching process, a solid-liquid separation process is performed on the leaching solution from the carbon dioxide leaching process to separate a leach residue from the leaching slurry. In this way, a concentrated lithium bearing leaching solution may be obtained. The concentrated lithium bearing solution may be collected for subsequent processing.

Any suitable solid-liquid separation process may be used. For instance, the solid-liquid separation process may comprise a filtration process, an evaporation or drying process or the like. In other embodiments, a settling or decantation process (such as a single-stage or multi-stage process conducted in a thickener) may be performed to separate a clarified leaching solution from the solid leaching residue.

In some embodiments of the invention, the leaching residue may, once separated from the leaching solution, be washed or otherwise cleaned in order to remove at least a portion of soluble species present thereon. The leaching residue may be washed or otherwise cleaned once, or may be washed or cleaned during two or more steps in the method.

It is envisaged that the leaching residue may form a tailings product from the extraction method. Beneficially, however, it is envisaged that the leaching residue may contain relatively high concentrations of potassium. It is envisaged that, rather than being collected in an environmental impoundment or stored in a tailings residue facility, the leaching residue may constitute a valuable by-product of the extraction method. For instance, the leaching residue, having a relatively high potassium concentration (and particularly a relatively high bioavailable potassium concentration), may be used as a fertiliser, and particularly a slow-release fertiliser.

The fertiliser may comprise any suitable quantity of potassium. For instance, the fertiliser may comprise between about 1% w/w potassium and about 20% w/w potassium. More preferably, the fertiliser may comprise between about 3% w/w potassium and about 16% w/w potassium. Still more preferably, the fertiliser may comprise between about 5% w/w potassium and about 15% w/w potassium.

Thus, the present invention provides a significant advantage in that, instead of generating a potentially hazardous tailings product that must undergo managed environmental storage or otherwise disposed of, the present invention generates a useful by-product, thereby reducing or eliminating waste produced by the method.

After the solid-liquid separation, the leaching solution is relatively free from solids and has a relatively high soluble lithium concentration. Lithium may then be precipitated from the leaching solution in the form of lithium carbonate by altering the solution chemistry.

Any suitable precipitation reaction may be used to precipitate lithium, depending on the specific process requirements. For example, additional heat can be applied to accelerate the reaction. However, at higher temperatures, carbon dioxide may be released from the leaching solution, which leads to the formation of carbonate ions. The presence of carbonate ions favours the precipitation of lithium carbonate, as lithium carbonate is significantly less soluble in the presence of carbonate ions compared to bicarbonate ions. As a result, lithium carbonate precipitates out of the solution. In this embodiment, the lithium carbonate precipitation proceeds according to the following reaction:

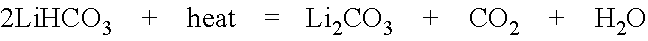

This reaction represents the thermal decomposition of lithium bicarbonate into lithium carbonate, carbon dioxide, and water. The controlled addition of heat ensures the efficient removal of lithium from the leaching solution in the form of lithium carbonate.

This reaction may also produce a minor quantity of soluble potassium carbonate as a byproduct. The potassium carbonate can be recycled back into the leaching process as a lixiviant, enhancing the overall efficiency and sustainability of the process by minimising waste.

In a preferred embodiment of the invention one or more ions may be introduced to the leaching solution in order to convert soluble lithium bicarbonate to relatively insoluble lithium carbonate.

Any suitable ions may be used, although in a preferred embodiment, the ions may comprise hydroxide ions (and may be provided in the form of, for instance, sodium hydroxide). More preferably, the hydroxide ions may be provided in the form of potassium hydroxide. In this embodiment, the lithium carbonate precipitation proceeds according to the following reaction:

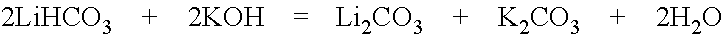

It will be understood that the following reaction may also occur when certain reactions conditions (i.e., the supply of 2 moles of KOH for each mole of LiHCO₃ present) are met:

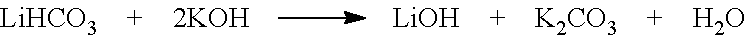

However, a skilled addressee will understand that, under certain reaction conditions, the production of lithium carbonate will occur according to the abovementioned formula. Specifically, when a supply of 2 moles of KOH for every 2 moles of LiHCO₃ is present, lithium carbonate will be produced. It will be understood that this reaction may be controlled by controlling the stoichiometry and/or pH of the reaction, such that soluble LiHCO₃ with the addition of KOH is used to produce insoluble Li₂CO₃ and soluble K₂CO₃.

It will therefore be understood that, in the present application, the reaction conditions are controlled so that 2 moles of KOH for every 2 moles of LiHCO₃ is present, thereby resulting in the production of insoluble Li₂CO₃ and soluble K₂CO₃.

Beneficially, the use of potassium hydroxide results in a leaching slurry containing aqueous potassium carbonate. Thus, once the precipitated lithium carbonate is separated from the leaching solution, the leaching solution may be returned to the leaching process as the lixiviant.

The precipitation of lithium carbonate may be performed in any suitable vessel, such as, but not limited to, a stirred tank reactor or a crystallizer.

In a preferred embodiment of the invention, the precipitation of lithium carbonate may be conducted at an elevated temperature. Preferably, the precipitation of lithium carbonate may be performed at a temperature of between about 30° C. and 90° C.

In some embodiments, the temperature of the leaching solution may be elevated using a heat source, such as a burner, steam injection, heater or the like. In an alternative embodiment, the temperature of the leaching solution may be elevated using a heat exchange process. The heat exchange fluid may be of any suitable type, although in a preferred embodiment of the invention, the heat exchange fluid may comprise the leaching solution leaving the first or second leaching process. In this way, the leaching solution leaving the first or second leaching process may be cooled and the leaching solution undergoing lithium carbonate precipitation may be heated, thereby reducing or eliminating the need for an external heat source.

Precipitated lithium carbonate may be separated from the leaching solution using any suitable technique. For instance, the precipitated lithium carbonate may be separated using a filtration process, an evaporation or drying process or the like. In other embodiments, a settling or thickening process may be performed to separate a clarified leaching solution from the precipitated lithium carbonate.

It has been found that the extraction method of the present invention results in a commercially viable recovery of lithium from the lithium bearing material. In addition, the lithium carbonate product produced by the method is of a relatively high purity. Further, the present method generates streams that may be recycled to other points in the process, thereby reducing reagent costs. Finally, and as previously mentioned, the present invention generates a useful by-product rather than a potentially hazardous tailings product that must be stored or otherwise disposed of.

In a fourth aspect, the invention resides broadly in a method for the extraction of lithium from a lithium bearing material containing alpha spodumene, the method comprising the steps of:
Converting at least a portion of the alpha spodumene present in the lithium bearing material to beta spodumene;
Subjecting the lithium bearing material to a leaching process at an elevated pressure in the presence of potassium carbonate to produce a leaching slurry including lithium carbonate;
Performing a carbon dioxide leaching process on the leaching slurry to produce a bicarbonate leaching slurry in which at least a portion of the lithium carbonate is converted to lithium bicarbonate;
Performing a solid-liquid separation process on the bicarbonate leaching slurry to separate a leach residue from a leaching solution;
Precipitating lithium carbonate from the leaching solution; and
Separating precipitated lithium carbonate from the leaching solution.

In a fifth aspect, the invention resides broadly in a method for the extraction of lithium from a lithium bearing material comprising spodumene, the method comprising converting at least a portion of the alpha spodumene present in the lithium bearing material to beta spodumene, subjecting the lithium bearing material to a leaching process at a pressure of greater than 2500 kPa and a temperature of greater than 250° C. but less than 300° C. in the presence of potassium carbonate to produce a leaching slurry containing lithium carbonate.

In a sixth aspect, the invention resides broadly in a method for the extraction of lithium from a lithium bearing material comprising spodumene, the method comprising the steps of:
converting at least a portion of the alpha spodumene present in the lithium beating material to beta spodumene;
subjecting the lithium bearing material to a quenching process to generate a slurry of lithium bearing material;
subjecting the slurry to a size reduction process to generate relatively fine particles; and
subjecting the relatively fine particles to a leaching process at a pressure of greater than 2500 kPa and a temperature of greater than 250° C. but less than 300° C. in the presence of potassium carbonate to produce a leaching slurry containing lithium carbonate.

The lithium bearing material may be of any suitable form. For instance, the lithium bearing material may comprise an ore, a concentrate, a residue or waste product or the like, or any suitable combination thereof. Preferably, however, at least a portion of the lithium in the lithium bearing material is present in the form of spodumene.

The spodumene present in the lithium bearing material may be in the form of alpha spodumene, beta spodumene or a combination thereof. It is envisaged that alpha spodumene is more likely to be present in naturally-occurring materials, such as lithium ores and mineral concentrates, while beta spodumene is more likely to be present in processed materials such as concentrates (including thermally processed concentrates and the like).

In some embodiments of the invention, the lithium bearing material may undergo one or more treatment steps prior to the leaching step. Any suitable treatment steps may be performed, such as a size reduction step, a separation step, a classification step or the like. In a particular embodiment of the invention, the lithium bearing material may undergo a conversion step to convert at least a portion of the alpha spodumene present in the lithium bearing material to beta spodumene.

The conversion step may be of any suitable form, although in a preferred embodiment of the invention the conversion step may comprise a thermal processing step. Specifically, the lithium bearing material may be subject to a roasting process, calcining process or the like, at an elevated temperature to convert at least a portion of the alpha spodumene to beta spodumene. Any suitable elevated temperature may be used, although in a preferred embodiment, the elevated temperature may be between approximately 800° C. and 1200° C. More preferably, the elevated temperature may be between approximately 900° C. and 1100° C.

The thermal processing step may be performed for any suitable period of time, and it will be understood that the length of the thermal processing process may depend on a number of factors, such as the quantity of alpha spodumene present in the lithium bearing material, the particle size of the lithium bearing material, the minerals present in the lithium bearing material and so on.

Preferably the lithium bearing material is substantially cooled before being subjected to a size reduction or comminution process. The lithium bearing material may be cooled using any suitable process. The specific manner in which the lithium bearing material is cooled is not critical to the invention, although in some embodiments of the invention the lithium bearing material may be subjected to a quenching process and, in particular, an atmospheric pressure quenching process. In a preferred embodiment of the invention, the cooling of the lithium bearing material may reduce the temperature of the lithium bearing material to between about 60° C. and 160° C. More preferably, the cooling of the lithium bearing material may reduce the temperature of the lithium bearing material to between about 70° C. and 160° C. Most preferably, the cooling of the lithium bearing material may reduce the temperature of the lithium bearing material to between about 80° C. and 160° C.

In some embodiments of the invention, the lithium bearing material may be subjected to a size reduction process prior to the leaching process. Any suitable size reduction process may be used, although in a preferred embodiment of the invention the size reduction process may comprise a comminution process, such as crushing, grinding or the like. The comminution process may be performed using any suitable method, such as ball milling, vertical stirred milling, jet milling, or any other suitable mechanical grinding. The grinding process may be performed as a wet or dry process, but in the preferred embodiment, the grinding process may be a wet grinding process using recycled potassium carbonate lixiviant solution.

It is envisaged that the grinding process may reduce the particle size of the lithium bearing material present in the leach slurry.

In some embodiments, the slurry may, having undergone the size reduction process, be subject to a classification process. Any suitable classification process may be used, although it is preferred that the classification process may be configured to separate the relatively fine particles from relatively coarse particles. In some embodiments the classification process may be performed using one or more hydrocyclones, spiral separators, screens or the like, or any suitable combination thereof.

It is envisaged that the relatively fine beta spodumene particles in the carbonate leaching slurry may subsequently undergo a leaching process.

As previously stated, the leaching of the lithium bearing material is performed at an elevated pressure. It will be understood that the term “elevated pressure” refers to a pressure that is greater than atmospheric pressure. In a preferred embodiment, the leaching of the lithium bearing material is performed at a pressure of greater than 2500 kPa. More preferably, the leaching of the lithium bearing material is performed at a pressure of greater than 3500 kPa. Still more preferably, the leaching of the lithium bearing material is performed at a pressure of greater than 4500 kPa. Most preferably, the leaching of the lithium bearing material is performed at a pressure of greater than 5000 kPa. In a specific embodiment, the leaching of the lithium bearing material is performed at a pressure of between about 4500 kPa and 5500 kPa.

In some embodiments of the invention, it is envisaged that the pressure at which the leaching of the lithium bearing material is performed may be greater than the steam pressure at a given temperature. In these embodiments of the invention, the pressure may be increased to greater than the steam pressure in order to reduce or eliminate the boiling of liquid in the leaching vessel. While the pressure may be raised to any suitable level, it is envisaged that the pressure may be at least 30 kPa above the steam pressure. In a preferred embodiment, the pressure in the leaching vessel may be raised by between 300 kPa and 600 kPa above the steam pressure.

The leaching process may be conducted in any suitable vessel. Preferably, however, the vessel comprises a pressure vessel. In a particular embodiment of the invention, the vessel comprises an autoclave. In some embodiments of the invention, the pressure vessel may be agitated. In a specific embodiment, the pressure vessel may be in the form of a stirred horizontal autoclave, Pachuca tank, or a pipe reactor.

It is envisaged that the leaching process may be performed at an elevated temperature. It will be understood that the term “elevated temperature” refers to a temperature that is greater than ambient temperature. In a preferred embodiment, the leaching of the lithium bearing material is performed at a temperature of greater than 250° C. More preferably, the leaching of the lithium bearing material is performed at a temperature of greater than 250° C. but less than 300° C. More preferably, the leaching of the lithium bearing material is performed at a temperature of greater than 250° C. but less than 285° C. Most preferably, the leaching of the lithium bearing material is performed at a temperature of greater than 250° C. but less than 270° C.

The leaching solution containing lithium carbonate may then be further processed in a method analogous to the steps described in the first aspect of the invention to produce a lithium carbonate product.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 illustrates a method for the extraction of lithium according to a first embodiment of the present invention.

FIG. 2 illustrates a method for the extraction of lithium according to a second embodiment of the present invention.

FIG. 3 illustrates a method for the extraction of lithium according to a fourth embodiment of the present invention.

FIG. 4 illustrates a method for the extraction of lithium according to a fifth embodiment of the present invention.

FIG. 5 illustrates a method for the extraction of lithium according to a third embodiment of the present invention.

### DETAILED DESCRIPTION

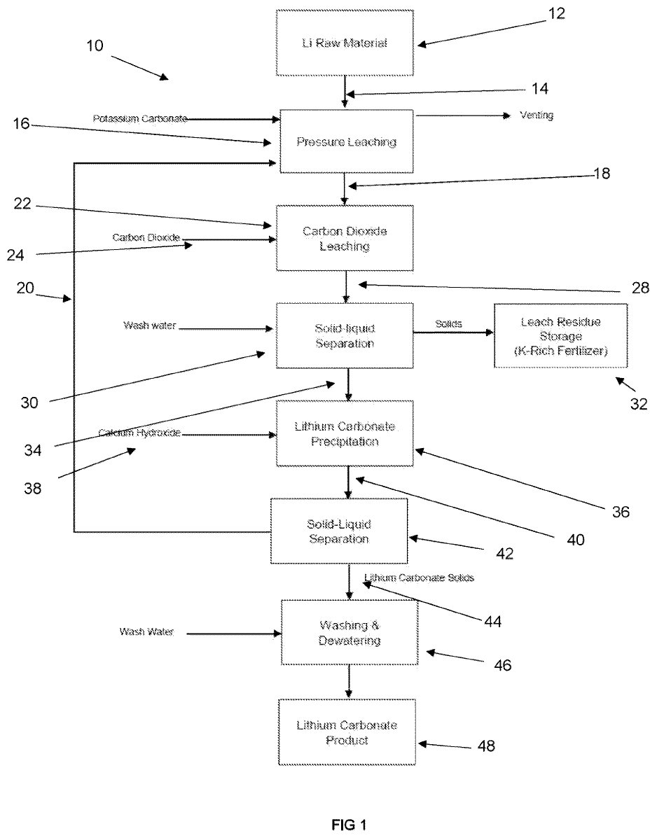

FIG. 1 illustrates a method 10 for the extraction of lithium according to an embodiment of the present invention. In the method, a lithium raw material 12 is converted into a lithium bearing material 14 in the form of a lithium spodumene concentrate. The conversion of the lithium raw material 12 into the lithium bearing material 14 is conventional and no further discussion of this is required. The lithium bearing material 14 is a solid material.

The lithium bearing material 14 is subjected to a leaching process 16 which is performed at an elevated pressure in the presence of potassium carbonate solution. In the embodiment of the invention illustrated in FIG. 1, the lithium bearing material 14 is introduced to a lixiviant containing an aqueous solution of potassium carbonate. In general terms, the concentration of potassium carbonate in the lixiviant is between 30 g/L and 900 g/L, and it will be understood that the concentration of potassium carbonate in the lixiviant will be at least partially determined by the concentration of lithium in the lithium bearing material 14.

The leaching process 16 is performed in a horizontally stirred autoclave at a pressure of between about 4500 kPa and 5500 kPa, and at a temperature of greater than 250° C. but less than 270° C. The pressure of the leaching process 16 is configured to prevent boiling of the leaching process solution.

The residence time of the lithium bearing material 14 in the leaching process 16 will be dependent on a number of factors, including the quantity of lithium in the lithium bearing material 14, the concentration of potassium carbonate in the lixiviant, the pressure and temperature at which the leaching process 16 is conducted, the size of the leaching vessel and so on However, it will be understood that the residence time of the lithium bearing material 14 in the leaching process 16 will be determined at least partly by the time taken to extract substantially all, or at least a significant portion of, the lithium from the lithium bearing material 14.

The leaching slurry 18 is treated to recover heat from the leaching solution 18 at the conclusion of the leaching process 16. To do so, the leaching slurry 18 is subjected to a heat exchange process using a stream generated in another part of the method 10, such as a potassium bi-carbonate rich recycle stream 34.

At the conclusion of the leaching process 16, the leaching slurry 18 containing lithium carbonate (in both aqueous and solid form) and potassium aluminosilicate (solid leaching residue, a portion of which comprising the mineral leucite) in solid form is introduced to a carbonation process 20. The purpose of the carbonation process is to convert the solid lithium carbonate in the leaching slurry 18 to soluble lithium bicarbonate by reacting lithium carbonate with carbon dioxide 24.

The lithium carbonate converted to lithium bicarbonate may be the solid lithium carbonate in the leaching slurry 18, the aqueous lithium carbonate, or a combination of the two.

The carbonation process 22 in the embodiment depicted in FIG. 1 is performed at a temperature of no more than about 50° C., and at substantially atmospheric pressure.

Leaching slurry 28 exiting the carbonisation process 22 is in the form of an aqueous solution of lithium bicarbonate and solid leaching residue. The leaching slurry 28 is then subjected to a solid-liquid separation process 30 to separate a solid leach residue 32 from the leaching slurry 28 in order to produce a leaching solution 34 having a high lithium concentration.

The solid-liquid separation process 30 comprises a filtration process performed to separate a clarified leaching solution 34 from the solid leaching residue 32.

In the embodiment of the invention illustrated in FIG. 1, the solid leach residue 32, once separated from the leaching slurry 28, is washed in order to remove at least a portion of soluble species present thereon.

The solid leach residue 32 forms a by-product from the extraction method 10. The leaching residue 32 contains relatively high concentrations of potassium. In the embodiment of the invention shown in FIG. 1, the solid leach residue 32 forms a useful byproduct of the extraction method 10. Specifically, the solid leach residue 32 is configured for use as a fertiliser. In FIG. 1, the fertiliser comprises approximately 13% w/w of bioavailable potassium.

Following the solid-liquid separation process 30, the leaching solution 34 is relatively free from solids and has a relatively high lithium bi-carbonate concentration. The leaching solution 34 may therefore undergo a precipitation step 36 in the presence of calcium hydroxide 38 to precipitate lithium from the leaching solution 34 in the form of relatively insoluble lithium carbonate. In FIG. 1 the precipitation step 36 is performed at a temperature of greater than 50° C.

Following the precipitation step 36, the leaching solution 40 comprises solid lithium carbonate in an aqueous solution of potassium carbonate. A further solid-liquid separation step 42 is performed on the leaching slurry 40 to produce solid lithium carbonate 44 and a potassium carbonate recycle stream 20 which is recycled to the leaching process 16 for use as the lixiviant.

In FIG. 1 energy is recovered throughout the circuit 10. Specifically, heat from the relatively hot leaching slurry 18 exiting the leaching process 16 is exchanged with the recycle stream 34. In this way, the leaching slurry 18 leaving the leaching process 16 may be cooled and the feed to the Lithium Carbonate Precipitation Stage 36 may be heated, thereby reducing or eliminating the need for an external heat source.

In FIG. 1, the precipitated lithium carbonate 44 is washed and dewatered 46 to produce a relatively pure lithium carbonate product 48.

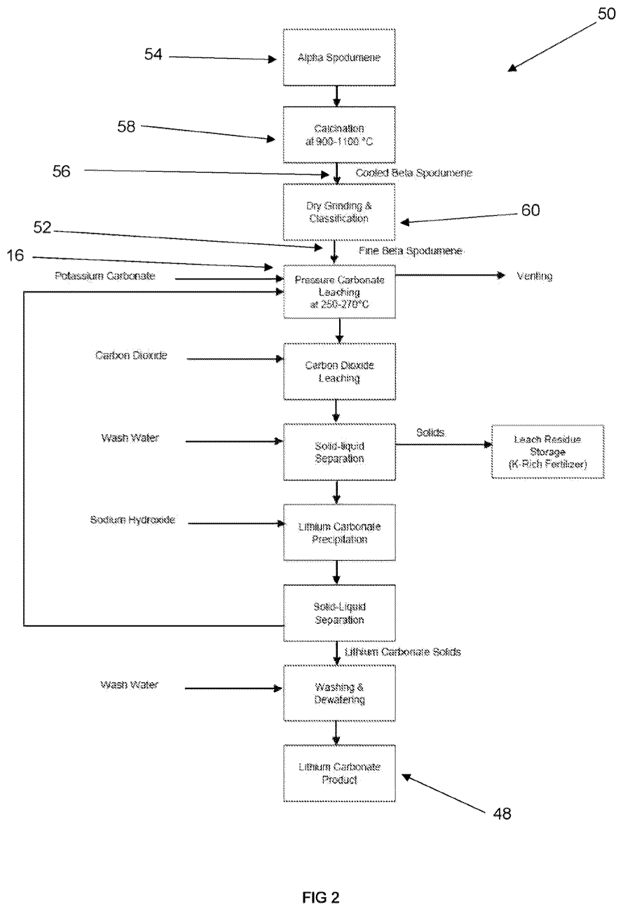

FIG. 2 illustrates a method 50 for the extraction of lithium according to an embodiment of the present invention. The method 50 of FIG. 2 is virtually identical to that of FIG. 1, with the exception that the lithium bearing material 52 introduced to the leaching process 16 is of a different origin to that of FIG. 1.

Specifically, the lithium raw material 54 in FIG. 2 is an alpha spodumene material (such as an ore). Prior to leaching 16, the alpha spodumene material 54 is converted to a beta spodumene material 56 by roasting or calcining 58 the alpha spodumene material 54 at a temperature of between 900° C. and 1100° C. until such time as substantially all of the alpha spodumene 54 has been converted to beta spodumene 56.

The beta spodumene material 56 that exits the roaster or calciner 58 is cooled prior to undergoing a comminution (grinding) and classification (screening) process 60 to separate relatively fine beta spodumene particles 52 from relatively coarse beta spodumene particles. Relatively coarse beta spodumene particles may be recycled within the comminution and classification process 60 to generate relatively fine beta spodumene particles 52 or may be discarded depending on the type of material.

The fine beta spodumene particles 52 may then be subjected to the leaching process 16 to ultimately produce relatively high purity lithium carbonate in the same manner as described with reference to FIG. 1.

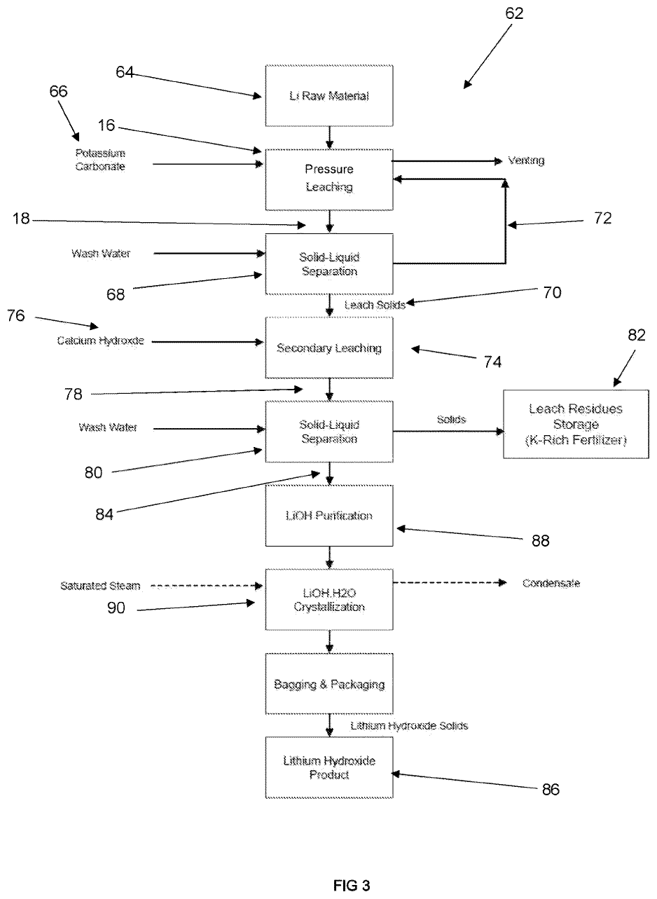

FIG. 3 illustrates a method 62 for the extraction of lithium according to an embodiment of the present invention.

The method 62 of FIG. 3 is similar to that of FIGS. 1 and 2 in that a beta spodumene material 64 is introduced to a pressure leaching process 16 in the presence of a potassium carbonate lixiviant 66 to produce a leaching slurry. At the conclusion of the leaching process 16, a leaching slurry 18 containing lithium carbonate (in both aqueous and solid form) and potassium carbonate in aqueous form is removed from the leaching process 16 along with the leach residue solids.

However, unlike in FIG. 1, the leaching slurry 18 is subjected to a solid-liquid separation process 68 (in the form of a filtration process or counter decantation process) to separate solid leach residue 70 containing lithium carbonate) from the leaching slurry 18. The separated solution 72 (which is relatively high in potassium carbonate) is returned to the leaching process 16 as the lixiviant.

The solid leach residue is subjected to a second leaching process 74 in the presence of hydroxide ions 76 (and, in the embodiment illustrated in FIG. 3, calcium hydroxide ions) to generate leaching slurry 78 containing an aqueous solution of lithium hydroxide.

The leaching slurry 78 also comprises solid leach residue 82 including calcium carbonate and potassium compounds. Thus, the leaching slurry 78 is subject to a further solid-liquid separation process 80 (in the form of a filtration process) to separate the solid leach residue 82 from the leaching slurry 78 to produce a concentrated lithium hydroxide solution 84.

As with FIG. 1, the solid leach residue 82 contains relatively high concentrations of potassium. In the embodiment of the invention shown in FIG. 3, the solid leach residue 82 forms a useful byproduct of the extraction method 62. Specifically, the solid leach residue 82 is configured for use as a potassium-rich fertiliser. In FIG. 3, the fertiliser comprises approximately 13% w/w of bioavailable potassium.

Prior to the production of a solid lithium hydroxide product 86, the concentrated lithium hydroxide solution 84 undergoes a purification step 88 in the form of a partial evaporation to crystallise relatively high purity lithium hydroxide monohydrate. In addition, the concentrated lithium hydroxide stream 84 is subjected to a crystallisation process 90, and particularly an evaporative crystallisation process, to produce lithium hydroxide crystals that form the solid lithium hydroxide product 86.

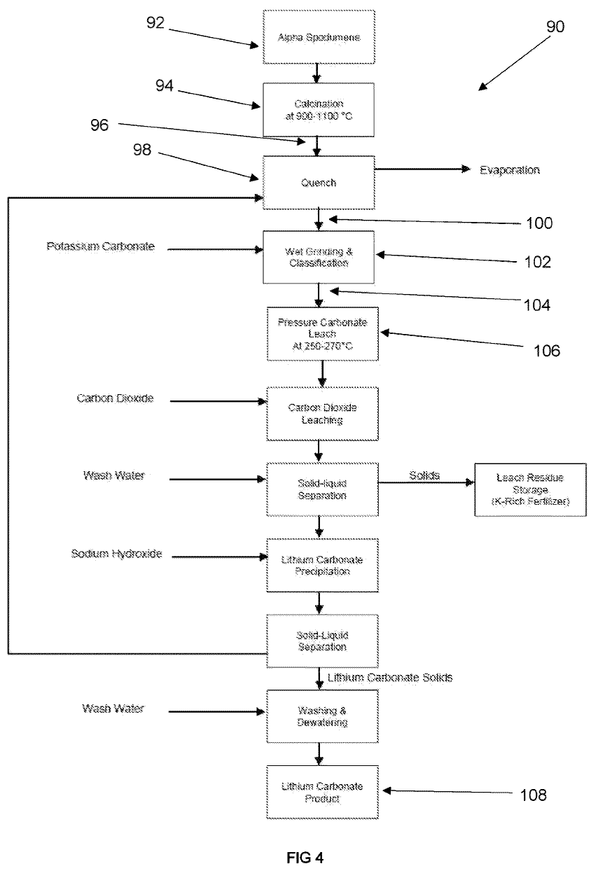

FIG. 4 illustrates a method 90 for the extraction of lithium according to an embodiment of the present invention.

The method 90 of FIG. 4 is similar to that of FIGS. 1 and 2 in that a beta spodumene material 96 is introduced to a pressure leaching process 106. In this method 90, the hot beta spodumene 96 first undergoes a quenching process 98 to produce a beta spodumene hot slurry 100. The beta spodumene hot slurry 100 then undergoes a wet grinding and classification step 102 to provide fine beta spodumene 104.

The fine beta spodumene 104 is then introduced to the potassium carbonate pressure carbonate leaching step 106.

The fine beta spodumene 104 may then be subjected to the leaching process 106 to produce a lithium carbonate product 108 in the same manner as described with reference to FIG. 1.

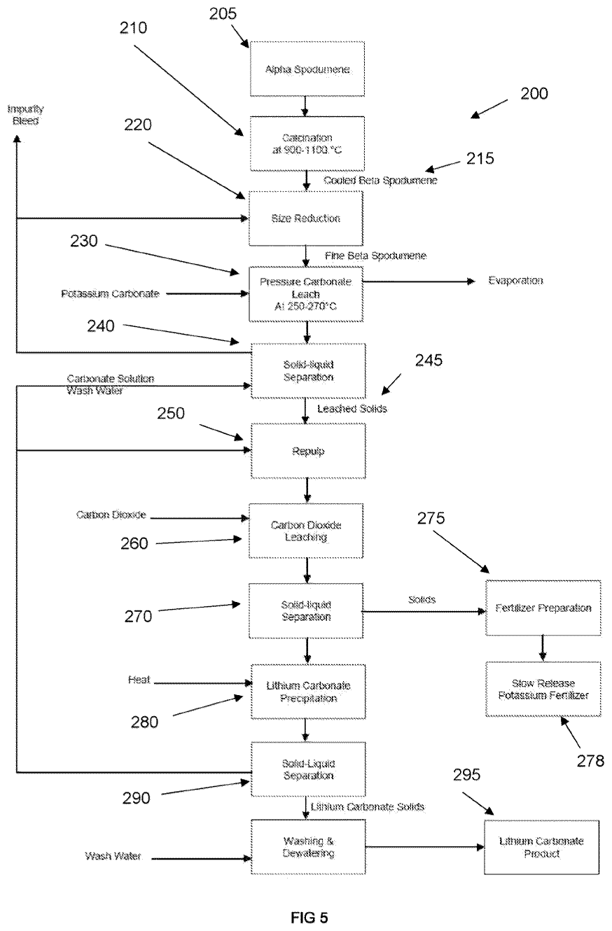

FIG. 5 illustrates a method 200 for the extraction of lithium according to an embodiment of the present invention. In the method, a lithium bearing material 205 containing alpha spodumene is feed into a spodumene conversion process 210 to convert at least a portion of the alpha spodumene presented in the lithium bearing material 205 into beta spodumene 215.

The conversion of a portion of the alpha spodumene present in the lithium bearing material 205 to beta spodumene 215 comprises a calcining processing step at an elevated temperature between approximately 900° C. and 1100° C.

The lithium bearing material 215 then undergoes a size reduction step 220 to reduce the particle size of the lithium bearing material 215.

After the size reduction step 220, the lithium bearing material 215 is subjected to a first leaching process 230 which is performed at an elevated pressure in the presence of potassium carbonate solution, preferably, an aqueous solution of potassium carbonate. This leaching process 230 is performed at an elevated temperature of approximately 250° C.

A leaching reaction happens during this leaching process 230, results in the extraction of lithium from the beta spodumene through the exchange of lithium and potassium ions. The lithium carbonate generated by the leaching reaction is present in the form of a precipitated solid and/or in aqueous form in the leaching solution.

A solid-liquid separation process 240 is then performed to separate a clarified solution from the leached solids 245.

The leached solids 245, once separated from the clarified solution, are washed or otherwise cleaned in order to remove at least a portion of soluble species present thereon.

The leached solids 245 are repulped in the presence of a recycled lithium and potassium carbonate solution in a repulping process 250.

The repulping process 250 is performed at a temperature of about 90° C. The temperature of the repulped slurry will be cooled to a temperature of less than 40° C. prior to advancing to the carbon dioxide leaching process 260.

Next, a carbon dioxide leaching process 260 is performed on the slurry from the repulping process 250 to convert at least a portion of the lithium carbonate in the leaching slurry to lithium bicarbonate. The carbon dioxide leaching process 260 may be performed at atmospheric pressure in continuously stirred tank reactors or autoclaves.

Following the carbon dioxide leaching process 260, a solid-liquid separation process 270 is performed on the leaching slurry from the carbon dioxide leaching process 260 to separate a leach residue 275 from the leaching slurry. The leaching residue 275, once separated from the leaching slurry, is washed or otherwise cleaned in order to remove at least a portion of soluble species present thereon.

The leaching residue 275, which may have a relatively high potassium concentration, can be used as a fertiliser, and particularly a slow-release fertiliser 278.

After the solid-liquid separation process 270, the leaching solution is relatively free from solids and has a relatively high soluble lithium concentration. Lithium is then be precipitated from the leaching solution in the form of lithium carbonate by altering the solution chemistry in the precipitation process 280.

Additional heat is applied to facilitate the reaction of the precipitation process 280. The controlled addition of heat ensures the efficient removal of lithium from the leaching solution in the form of lithium carbonate.

This reaction can produce a minor quantity of soluble potassium carbonate as a byproduct. However, the lithium and potassium carbonate solution can be recycled back into the repulping process 250 as a lixiviant, enhancing the overall efficiency and sustainability of the process by minimising waste.

The precipitation of lithium carbonate 280 is performed in a stirred tank reactor or a crystallizer with the temperature of the leaching slurry being elevated using a heat exchange process. The heat exchange fluid may comprise the leaching slurry leaving the leaching process 230 or the repulping process 250.

During the solid-liquid separation process 290, the precipitated lithium carbonate 295 is separated from the carbonate leaching solution via thickening and/or filtration. The lithium carbonate 295 is washed with water and filtered to produce a moist lithium carbonate filter cake.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1-86. (canceled)

87. A method for the extraction of lithium from a lithium bearing material containing alpha spodumene, the method comprising:
converting at least a portion of the alpha spodumene present in the lithium bearing material to beta spodumene;
subjecting the lithium bearing material to a leaching process at an elevated pressure in the presence of potassium carbonate to produce a leaching slurry containing lithium carbonate;
performing a carbonation process on the leaching slurry to convert at least a portion of the lithium carbonate to lithium bicarbonate;
performing a solid-liquid separation process on the leaching slurry to separate a leach residue from the leaching solution;
precipitating lithium carbonate from the leaching solution; and
separating precipitated lithium carbonate from the leaching solution.

88. The method according to claim 87, wherein the lithium mineral comprises a hard rock lithium mineral.

89. The method according to claim 88, wherein the lithium mineral comprises one or more of spodumene, lepidolite, eucryptite and petalite.

90. The method according to claim 87, wherein the conversion step is a thermal processing step comprising a roasting process or a calcining process.

91. The method according to claim 90, wherein the thermal processing step is performed at an elevated temperature of between approximately 800° C. and 1200° C.

92. The method according to claim 87, wherein the leaching process is performed at a temperature at which a natural vapour pressure is greater than 2500 kPa.

93. The method according to claim 92, wherein the elevated pressure is up to 700 kPa above the natural vapour pressure.

94. The method according to claim 87, wherein the leaching process is performed at a temperature of greater than 250° C. but less than 300° C.

95. The method according to claim 94, wherein the leaching process is performed at a temperature below a boiling point of the leaching solution.

96. The method according to claim 87, wherein the potassium carbonate is in the form of a lixiviant containing potassium carbonate.

97. The method according to claim 87, wherein the leaching of the lithium bearing material proceeds according to the following reaction:

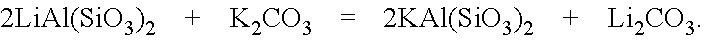

98. The method according to claim 87, wherein the lithium carbonate generated by the leaching processing is present in the form of a precipitated solid and/or in aqueous form in the leaching solution.

99. The method according to claim 87, wherein the leaching slurry is treated to recover heat at a conclusion of the leaching process.

100. The method according to claim 87, wherein the lithium carbonate is converted to lithium bicarbonate according to the following reaction:

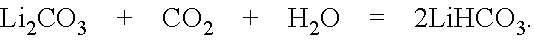

101. The method according to claim 87, wherein the carbonation process is performed at a temperature of no more than about 70° C.

102. The method according to claim 87, wherein lithium carbonate is precipitated from the leaching solution according to the following reaction:

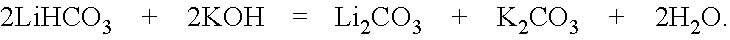

103. A method for the extraction of lithium from a lithium bearing material containing alpha spodumene, the method comprising:
converting at least a portion of the alpha spodumene present in the lithium bearing material to beta spodumene;
subjecting the lithium bearing material to a first leaching process at an elevated pressure in the presence of potassium carbonate to precipitate lithium carbonate;
subjecting the lithium carbonate to a second leaching process in the presence of hydroxide ions to produce a leaching solution containing an aqueous solution of lithium hydroxide;
separating a solid leach residue from the leaching solution to produce a concentrated lithium hydroxide solution; and
producing a solid lithium hydroxide product from the concentrated lithium hydroxide solution.

104. The method according to claim 103, wherein the lithium bearing material comprises a lithium mineral, the lithium mineral being spodumene, lepidolite, eucryptite and petalite.

105. The method according to claim 103, wherein the conversion step is a thermal processing step comprising a roasting process or a calcining process.

106. The method according to claim 105, wherein the thermal processing step is performed at an elevated temperature of between approximately 800° C. and 1200° C.

107. The method according to claim 103, wherein the elevated pressure of the first leaching process is greater than 2500 kPa.

108. The method according to claim 107, wherein the elevated pressure of the first leaching process is raised by between 300 kPa and 600 kPa above steam pressure at a given temperature.

109. The method according to claim 103, wherein the first leaching process is performed at a temperature of greater than 250° C. but less than 300° C.

110. The method according to claim 103, wherein the first leaching process proceeds according to the following reaction:

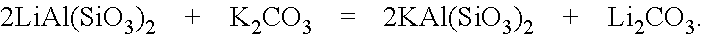

111. The method according to claim 103, wherein a solid-liquid separation process is performed on a stream exiting the first leaching process and prior to the second leaching process to separate the lithium carbonate from the leaching solution.

112. A method for the extraction of lithium from a lithium bearing material containing alpha spodumene, the method comprising:
converting at least a portion of the alpha spodumene present in the lithium bearing material to beta spodumene;
subjecting the lithium bearing material to a leaching process at an elevated temperature in the presence of potassium carbonate to produce a leaching slurry containing lithium carbonate;
performing a carbon dioxide leaching process on the leaching slurry to produce a bicarbonate leaching slurry in which at least a portion of the lithium carbonate is converted to lithium bicarbonate;
performing a solid-liquid separation process on the bicarbonate leaching slurry to separate a leach residue from a leaching solution;
precipitating lithium carbonate from the leaching solution; and
separating precipitated lithium carbonate from the leaching solution.

113. A method for the extraction of lithium from a lithium bearing material containing alpha spodumene, the method comprising:
converting at least a portion of the alpha spodumene present in the lithium bearing material to beta spodumene;
subjecting the lithium bearing material to a first leaching process at an elevated pressure in the presence of potassium carbonate to produce a leaching slurry containing lithium carbonate;
performing a carbon dioxide leaching process on the leaching slurry to produce a bicarbonate leaching slurry in which at least a portion of the lithium carbonate is converted to lithium bicarbonate;
performing a solid-liquid separation process on the bicarbonate leaching slurry to separate a leach residue from a leaching solution;
precipitating lithium carbonate from the separated leaching solution; and
separating precipitated lithium carbonate from the leaching solution.

114. A method for the extraction of lithium from a lithium bearing material comprising alpha spodumene, the method comprising:
converting at least a portion of the alpha spodumene present in the lithium bearing material to beta spodumene, subjecting the lithium bearing material to a leaching process at a pressure of greater than 2500 kPa and a temperature of greater than 250° C. but less than 300° C. in the presence of potassium carbonate to produce a leaching slurry containing lithium carbonate.

115. A method for the extraction of lithium from a lithium bearing material comprising spodumene, the method comprising:
converting at least a portion of the alpha spodumene present in the lithium bearing material to beta spodumene;
subjecting the lithium bearing material to a quenching process to generate a slurry of lithium bearing material;
subjecting the slurry to a size reduction process to generate relatively fine particles; and
subjecting the relatively fine particles to a leaching process at a pressure of greater than 2500 kPa and a temperature of greater than 250° C. but less than 300° C. in the presence of potassium carbonate to produce a leaching slurry containing lithium carbonate.
